(19) United States
(12) Patent Application Publication
(10) Pub. No.: US 2009/0184527 A1
(43) Pub. Date: Jul. 23, 2009

(54) MUSCLE AND CARDIOVASCULAR STRAIN REDUCING SNOW SHOVEL

(76) Inventor: Tucker J. Marion, Holliston, MA (US)

Correspondence Address: BUCHANAN, INGERSOLL & ROONEY PC, POST OFFICE BOX 1404, ALEXANDRIA, VA, 22313-1404, US

(21) Appl. No.: 12/357,864

(22) Filed: Jan. 22, 2009

Related U.S. Application Data
(60) Provisional application No. 61/006,555, filed on Jan. 22, 2008.

(51) Int. Cl. E01H 5/02; A01B 1/02; B25G 1/10

(52) U.S. Cl. 294/54.5; 294/57

(57) ABSTRACT

The snow shovel described herein allows maximum efficiency by using the natural mechanical advantage of placing the load on a specially configured shovel head. The shovel has the ability to push snow (like a snowplow) and also to lift and dump, maximizing the use of the ground as a point of leverage.

### FIELD OF THE INVENTION

The present invention relates to shovels.

### DESCRIPTION OF THE RELATED ART AND BACKGROUND OF THE INVENTION

The shovel described here greatly reduces the effort and strain of cardiovascular and muscle activity during manual snow removal. There exists a need for a shovel which greatly reduces the negative impact on the body during the shoveling act. Below is an excerpt from the Detroit Free Press, ‘Why Shoveling Snow Triggers Heart Attacks’ (Jan. 18, 2000):
An apparently healthy 58-year-old cardiac surgeon—who campaigned on local television and radio against smoking—dies of a heart attack while shoveling snow.
A retired newspaper photographer, clearing his Romeo driveway of snow to attend a family gathering, has a heart attack before he finishes and dies.
A 54-year-old supermarket cashier clears her driveway of snow to get to work. She has a heart attack and spends the next week in a coronary care unit.

Stories like these are all too familiar.

The names and faces change, but there is a common denominator: Middle-aged or older men and women shovel heavy, wet snow. Then they have a cardiac arrest or heart attack and often die.

In response to these alarming reports, a study was initiated at Beaumont Hospital in Royal Oak to clarify the physical demands of snow shoveling on 10 healthy but inactive men. The heart rate, blood pressure and energy expenditure were monitored while each subject cleared a tract of heavy, wet snow in the cold for 10 minutes with a lightweight plastic shovel.

Researchers found that snow shoveling requires about the same energy expenditure as an active round of singles tennis or speed walking at 5 m.p.h. For elderly or unfit people, these activities can be Herculean efforts.

The most surprising discovery was shoveling's disproportionate strain on the heart. The blood pressure and heart rates of the subjects rose to dangerously high levels, averaging 200 millimeters of mercury and 175 beats per minute, respectively. These values were comparable to or higher than the maximum responses the same subjects achieved during exhaustive treadmill testing.

How are these responses linked to the cardiac events commonly reported after heavy snowfalls? Among people with heart disease, such high numbers can lead to inadequate oxygen supply to the heart muscle, anginal chest pain and potentially fatal heart rhythm disturbances. The marked increases in heart rate and blood pressure that accompany snow shoveling may cause greater-than-usual flows that dislodge pieces of cholesterol and other fragments from blood vessel walls. The result: a heart attack.

Another surprising measure taken in the tests was the magnitude of physical work. The average weight of a shovel loaded with heavy, wet snow is about 16 pounds. The typical subject shoveled 12 times a minute, moving 192 pounds of snow. Over 10 minutes, each lifted almost 2,000 pounds.

Although there are plow-like devices and even wheeled shovels, none combine the ease of use and effectiveness of the proposed design. Current offerings are universally one dimensional products, and are not effective against multiple types, and thicknesses of snow. They also usually push snow, not having the capability to lift and dump easily.

### SUMMARY OF THE INVENTION

A preferred embodiment of a shovel according to the present invention comprises a shovel head with the shovel head comprising a lower surface that is generally curved from top to bottom and that is generally curved from side to side. The shovel also comprises a main handle comprising a first end and a second end with the main handle being connected at the first end to the shovel head and a rear handle provided at the second end of the main handle.

In another preferred embodiment of the shovel according to the present invention, the shovel head is generally bubble shaped and the main handle is generally S-shaped.

In another preferred embodiment, the rear handle comprises a generally vertical grip and a T-shaped grip and the rear handle further comprises a generally semi-circular grip.

### BRIEF DESCRIPTION OF THE DRAWING FIGURES

The present invention will appear more clearly from the following detailed description of several embodiments illustrated in the enclosed figures in which:

FIG. 1 is a side view of a first embodiment of a shovel according to the present invention;

FIG. 2 is a schematic view of the shovel of FIG. 1;

FIG. 3 is a schematic view of a second embodiment of a shovel according to the present invention;

FIG. 4 is a generally end view of the second embodiment of a shovel of FIG. 3;

FIG. 5 is another view of the shovel of FIG. 3;

FIG. 6 is another view of the shovel of FIG. 3; and,

FIG. 7 is an end view of the shovel of FIG. 3.

### DETAILED DESCRIPTION OF THE PREFERRED EMBODIMENTS

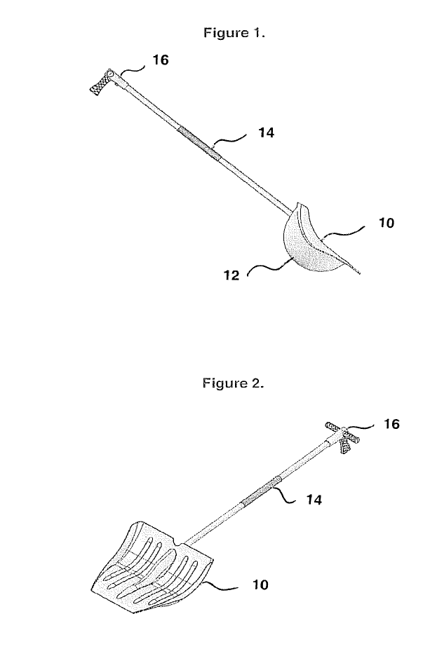

With reference to FIG. 1, a first preferred embodiment of a shovel according to the present invention has a shovel head 10 which includes a lower curved surface 12. The shovel head 10 is attached to one end of a main handle 14. A rear handle 16 or grip is provided at the other end of the main handle 14.

The snow shovel described here allows maximum efficiency by using a natural mechanical advantage of placing the load on a specially designed shovel head. The shovel has the ability to push snow (like a snowplow) and also to lift and dump, maximizing the use of the ground as a point of leverage. The configuration leverages the ground via a bottom mounted curved surface that acts as the shovel fulcrum (see FIG. 1), rather than the users' arms and back. This reduces muscle stress and associated increases in cardio vascular load. The overall architecture is similar to a wheel barrow, as the shovel allows the user to lift and carry heavy loads with maximum control. However, the product is also designed to be used as a normal shovel.

Typical winter conditions (a little more than an inch of snowfall and temperatures that dip below 20 degrees) cause death rates from heart attacks to triple among men 35 to 49 years old. Shoveling snow can be very dangerous if the right precautions are not taken.

What makes shoveling more dangerous than other average tasks around the house is the temperature. Heart rate and blood pressure increase during strenuous activity. That, coupled with the body's natural reflex to constrict arteries and blood vessels when exposed to the cold, is a recipe for a heart attack. That risk is reduced by using a shovel according to the present invention.

The shovel according to the present invention preferably saves the user's heart and back by shoveling without lifting. The specially designed bottom bubble and handle gives the user the leverage needed in three easy steps of pushing, tilting and then rolling the shovel about the bottom bubble. The bottom bubble is generally rounded in all directions to facilitate pivoting of the shovel from front to back and from side to side.

The shovel can also be used as a regular shovel with a specially designed handle and back saving shaft.

Although the front of the shovel head is narrow, the shovel clears as much or more snow in a pass as a regular shovel so more snow can be cleared per pass or scoop.

Even though the bottom of the shovel head touches the ground, it acts as a ski, it is very thick, and is preferably made of durable polypropylene. It may get scuffed, but, will generally not wear out.

The lower curved surface 12 is generally bubble shaped and acts as a fulcrum of the shovel. The lower curved surface allows the user to manipulate the shovel head without having to lift the snow contained in the upper shovel head 10 or bucket. The lower curved surface 12 which is provided on the bottom of the shovel head 10 allows for multi-axial movement of the shovel head 10.

The shovel head 10 has a front shovel-plow configuration which allows the user to both push snow and also enables lifting, scooping and side dumping operations by the user.

The shovel is configured with modular architecture to allow for different handle and shovel combinations such as a) with T-handle; b) without T-handle; c) with bottom curved surface; d) without bottom curved surface; etc.

The shovel is preferably made with a rugged design to enable use in snow and ice removal in outdoor temperature extremes. Preferably, the shovel is also constructed from common materials such as plastics, etc. to reduce cost and also to reduce weight.

The rear handle 16 preferably provides comfortable, ergonomic grips to allow maximum control of movement (e.g. dumping, lifting and side-to-side action). In this way, the shovel is configured to be very maneuverable and is able to be actuated like a small wheel barrow (to lift, to carry, to tilt; and to dump to the side and to the front).

The preferred T-shaped grips aid the user is pushing, tilting and rotating the shovel head.

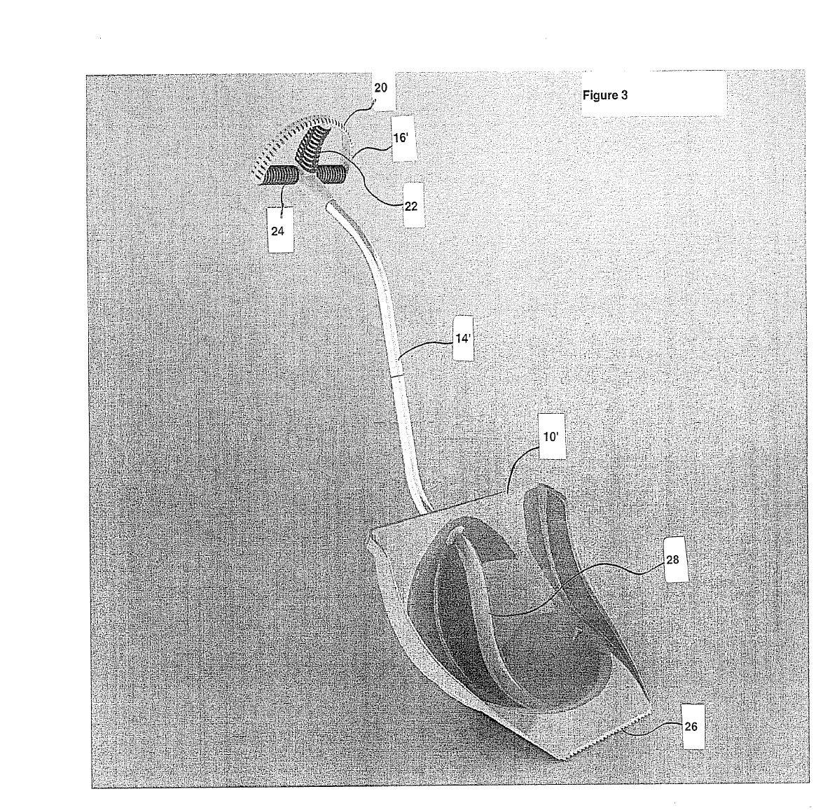

With reference now to FIG. 3, a preferred embodiment of the shovel according to the present invention includes a rear handle 16′ which has a semi-circular handle 20 or steering wheel as well as a vertical grip 22 and T-handle 24.

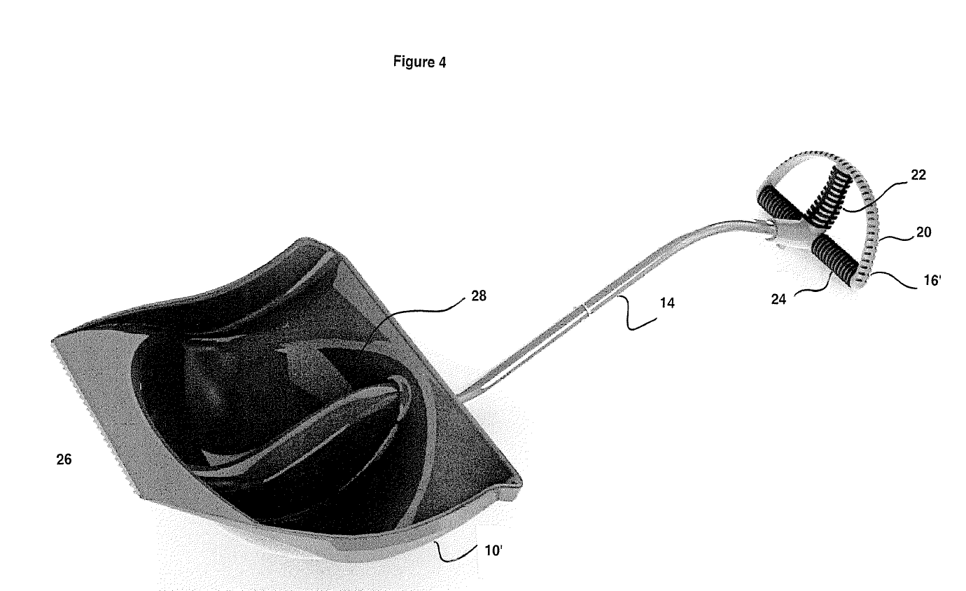

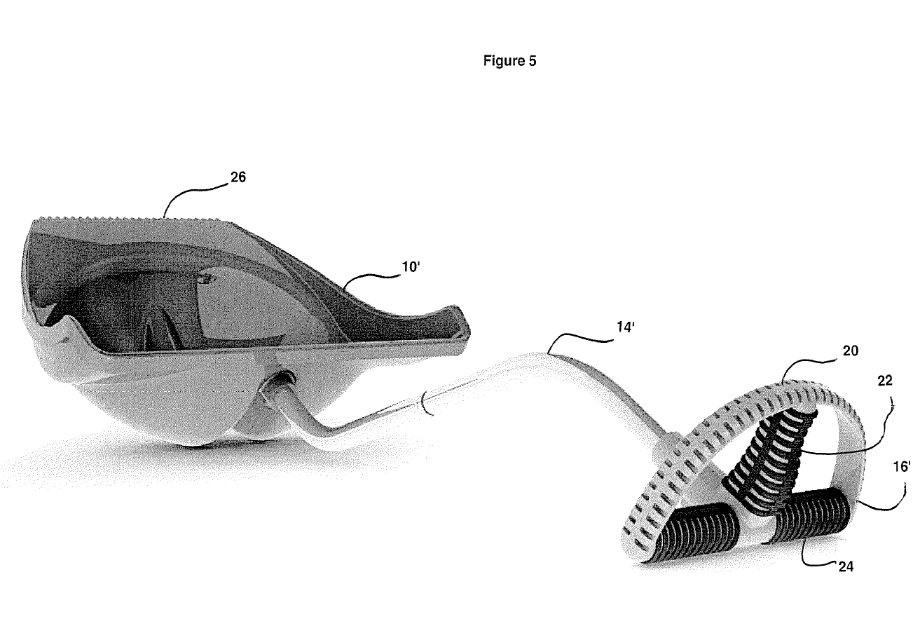

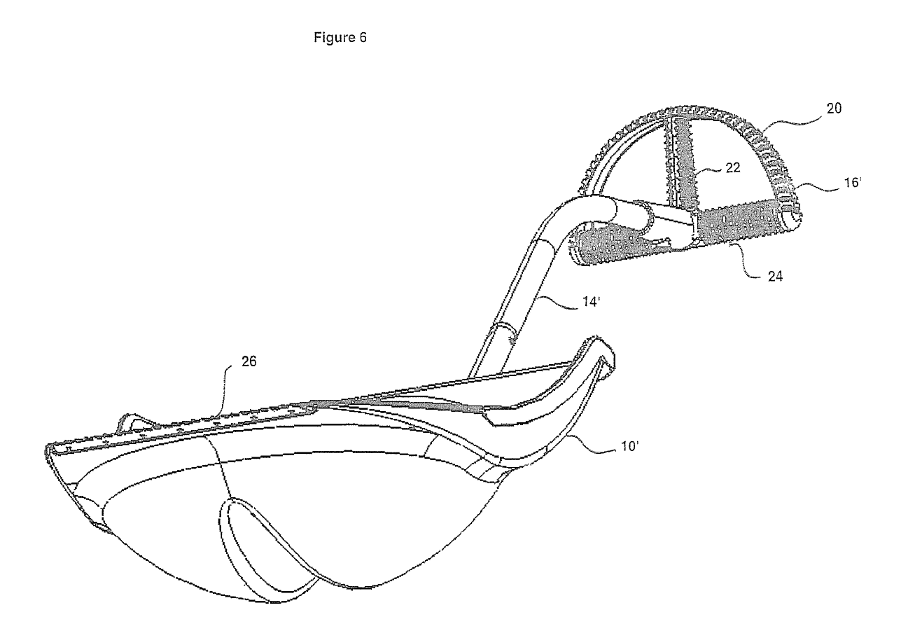

With reference also to FIGS. 4 and 5, the preferred embodiment of the shovel of FIG. 3 also includes a main handle 14′ which is formed of an aluminum “S” shaped shaft that is configured to maximize vertical pick-up of snow or other material. The S-shaped shaft has a mid-section which is easily grasped by the user with one hand while the user's other hand grips the rear handle 16′ during a shoveling operation.

With continued reference to FIG. 3, the preferred embodiment of the shovel has a shovel head 10′ or bubble with a rounded bottom that allows lifting, movement (i.e. especially sliding movement) and side dumping. The configuration of the rounded bottom surface of the shovel head 10′ has a naturally balanced shape so as to evenly distribute the weight or material contained within the shovel head 10′.

In addition, the rounded configuration of the lower shovel head facilitates “driving up” snow banks with the shovel. Preferably, the shovel head 10′ has a toothed or serrated front end 26 to facilitate scraping and cracking of ice and snow from a sidewalk or other surface.

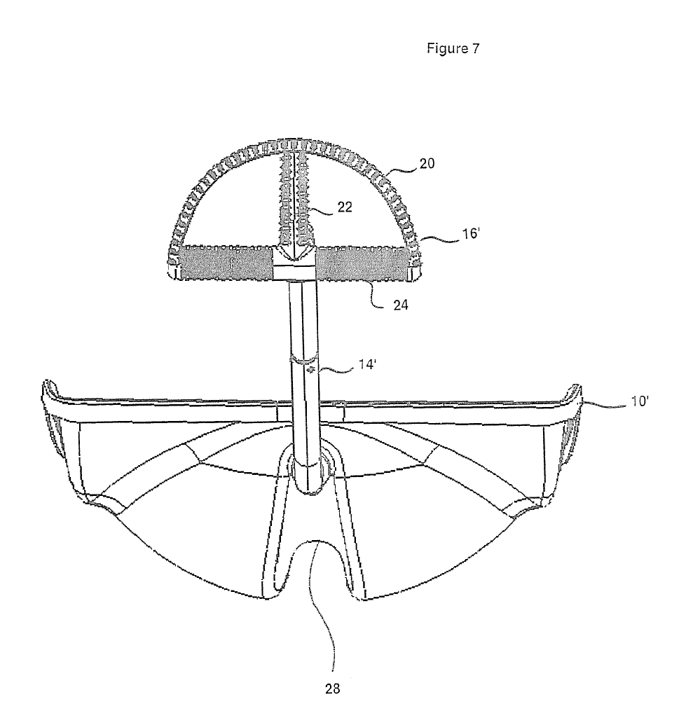

To provide additional rigidity, the shovel head 10′ also has a rib 28 (see also FIGS. 6 and 7) which receives the lower end of the main handle 14′. In addition, the angled head shape of the shovel head 10′ facilitates side dumping and rolling. The deep bubble configuration of the shovel head 10′ provides a large snow capacity and also facilitates use of the shovel with materials other than snow and ice.

The principles, preferred embodiments and mode of operation of the present invention have been described in the foregoing specification. However, the invention which is intended to be protected is not to be construed as limited to the particular embodiments disclosed. The embodiments are therefore to be regarded as illustrative rather than as restrictive. Variations and changes may be made without departing from the spirit of the present invention. Accordingly, it is expressly intended that all such equivalents, variations and changes which fall within the spirit and scope of the present invention as defined in the claims be embraced thereby.

What is claimed is:

1. A shovel, comprising:
a shovel head, the shovel head comprising a lower surface that is generally curved from top to bottom and that is generally curved from side to side;
a main handle, comprising a first end and a second end, the main handle being connected at the first end to the shovel head; and
a rear handle provided at the second end of the main handle.

2. The shovel according to claim 1, wherein the lower surface of the shovel head is generally bubble shaped.

3. The shovel according to claim 2, wherein the main handle is generally S-shaped.

4. The shovel according to claim 3, wherein the rear handle comprises a generally vertical grip and a T-shaped grip.

5. The shovel according to claim 4, wherein the rear handle further comprises a generally semi-circular grip.
